(19) United States
(12) Patent Application Publication
(10) Pub. No.: US 2011/0246222 A1
(43) Pub. Date: Oct. 6, 2011

(54) REVIEWING TESTS ON CLIENT DEVICES

(75) Inventors: Frederik W.E. Kroon, Auburn, NY (US); Mark E. Pingel, Camillus, NY (US); Kristin A. Alisanski, Syracuse, NY (US); Thomas A. Myers, Syracuse, NY (US); Avinash Gite, Charlotte, NC (US); Corrie A. Baum, Skaneateles, NY (US)

(73) Assignee: WELCH ALLYN, INC., Skaneateles Falls, NY (US)

(21) Appl. No.: 13/076,528

(22) Filed: Mar. 31, 2011

Related U.S. Application Data
(60) Provisional application No. 61/319,735, filed on Mar. 31, 2010.

(51) Int. Cl. G06Q 50/00

(52) U.S. Cl. 705/2

(57) ABSTRACT

A client device facilitates review of electrocardiogram (ECG) tests. The client device performs the ECG tests on one or more patients and sends results of the ECG tests to an Electronic Medical Record (EMR) system for storage. In addition, the client device displays a test history interface on a display screen. A user of the client device can select one of the ECG tests. In response, the client device communicates with one or more devices to retrieve results of the selected ECG test. The client device displays information about the selected ECG test on the display screen.

This application claims the benefit of U.S. Provisional Patent Application No. 61/319,735, filed Mar. 31, 2010, the entirety of which is hereby incorporated by reference.

### BACKGROUND

The health care industry is transitioning from paper medical records to electronic medical records (EMRs). The use of EMRs instead of paper medical records can provide many advantages. For example, it can be easier to share EMRs than paper medical records. In another example, the use of EMRs can reduce the amount of storage space needed and reduce clerical costs. However, healthcare providers need to use electronic devices to review EMRs. Frequently, the electronic devices needed to review EMRs are not present at locations where healthcare providers are monitoring or performing tests on patients.

### SUMMARY

In one aspect, the present disclosure is directed to a method for facilitating review of results of electrocardiogram (ECG) tests. The method comprises displaying a test history interface on a display screen of a client device, the test history interface listing at least some of the ECG tests. In addition, the method comprises receiving, by the client device, a selection of a given ECG test during a time that the display screen displays the test history interface, the given ECG test being among the ECG tests listed in the test history interface. Furthermore, the method comprises communicating, by the client device, with the one or more other devices to retrieve results of the given ECG test from an Electronic Medical Record (EMR) database. The method also comprises displaying the results of the given ECG test in the test history interface in response to receiving the selection of the given ECG test.

In another aspect, the present disclosure is directed to a physiological monitor device comprising a display screen, a health care equipment (HCE) module configured to receive signals from electrodes, one or more computer storage media that store computer-executable instructions; and a processing unit that accesses the computer-executable instructions and executes the computer-executable instructions. Execution of the computer-executable instructions configures the physiological monitor device such that the physiological monitor device performs a plurality of ECG tests on one or more patients using the signals received from the electrodes, communicates with one or more other devices to store results of the ECG tests in an EMR database associated with an EMR system; displays a test history interface on the display screen, the test history interface listing at least some of the ECG tests; receives a selection of a given ECG test during a time that the display screen displays the test history interface, the given ECG test being among the ECG tests listed in the test history interface; communicates with the one or more other devices to receive results of the given ECG test from the EMR database; and displays the results of the given ECG test in the test history interface in response to receiving the selection of the given ECG test.

### BRIEF DESCRIPTION OF THE DRAWINGS

FIG. 1 is a block diagram illustrating an example system for collecting measurements of physiological parameters of patients.

FIG. 2 illustrates an example physiological monitor device.

FIG. 3 illustrates an example user interface displayed on the display screen of FIG. 2.

FIG. 4 shows another example system for collecting measurements of physiological parameters of patients.

FIG. 5 illustrates example physical components of a device.

FIG. 6 is a flowchart illustrating an example operation of a device.

FIG. 7 is a flowchart illustrating a further portion of the example operation of FIG. 6.

FIG. 8 is a screen illustration of an example test history interface.

FIG. 9 is a screen illustration of an example editing interface.

FIG. 10 is a screen illustration of the example editing interface in a test comparison mode.

FIG. 11 is a screen illustration of an example test assignment interface.

### DETAILED DESCRIPTION

The present disclosure relates to a user interface for an interface system. The interface system is used in conjunction with a system for collecting, storing, and manipulating physiological measurements from a patient.

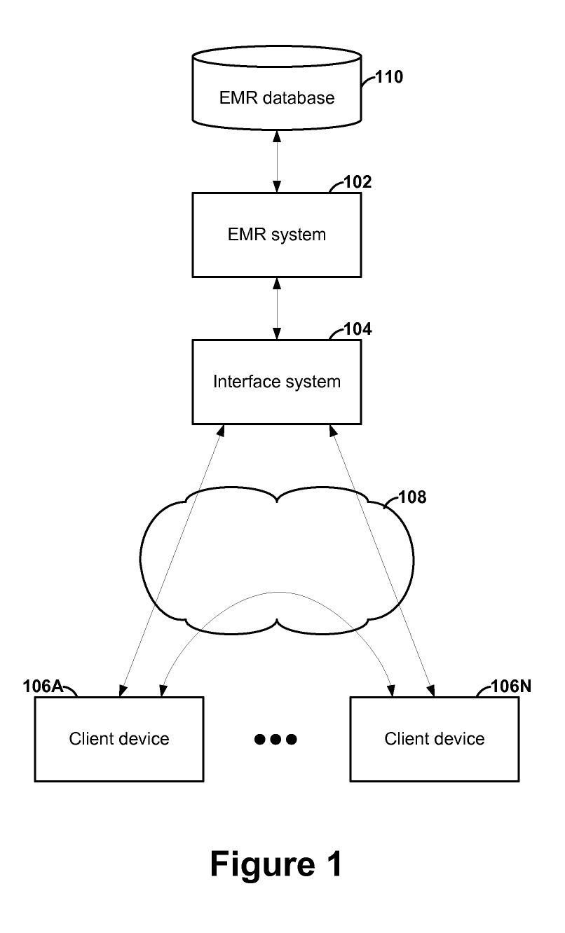

FIG. 1 is a block diagram illustrating an example system 100 for collecting measurements of physiological parameters of patients. As illustrated in the example of FIG. 1, the system 100 comprises an Electronic Medical Records (EMR) system 102, an interface system 104, a set of client devices 106A-106N (collectively, “client devices 106”), and a network 108.

In one example, the system 100 is a CONNEX® system from Welch Allyn, Inc. of Skaneateles Falls, N.Y., although other systems can be used.

The network 108 is an electronic communication network that facilitates communication between the client devices 106 and between the client devices 106 and the interface system 104. An electronic communication network is a set of computing devices and links between the computing devices. The computing devices in the network use the links to enable communication among the computing devices in the network. The network 108 can include routers, switches, mobile access points, bridges, hubs, intrusion detection devices, storage devices, standalone server devices, blade server devices, sensors, desktop computers, firewall devices, laptop computers, handheld computers, mobile telephones, and other types of computing devices. In various embodiments, the network 108 includes various types of links. For example, the network 108 can include wired and/or wireless links. Furthermore, in various embodiments, the network 108 is implemented at various scales. For example, the network 108 can be implemented as one or more local area networks (LANs), metropolitan area networks, subnets, wide area networks (such as the Internet), or can be implemented at another scale.

The EMR system 102 is a computing system that allows storage, retrieval, and manipulation of electronic medical records. The EMR system 102 comprises one or more computing devices. Computing devices comprise physical, tangible devices that process data. Example types of computing devices include personal computers, standalone server computers, blade server computers, mainframe computers, handheld computers, smart phones, special purpose computing devices, and other types of devices that process data.

The EMR system 102 stores, retrieves, and manipulates electronic medical records in a EMR database 110. The EMR database 110 comprises one or more data structures that store electronic medical records. Various embodiments implement the EMR database 110 in various ways. For example, the EMR database 110 can comprise a relational database, an object oriented database, or another type of database.

Each client device in the set of client devices 106 comprises a computing device. The client devices 106 can provide various types of functionality. For example, the set of client devices 106 can include one or more physiological monitor devices (such as the physiological monitor device 200). In addition, the set of client devices 106 can include one or more desktop, laptop, or wall-mounted devices. Such devices can have similar functionality to the physiological monitor device 200 but are stationary instead of portable, such as workstation devices (such as the VM workstation 450). In addition, the set of client devices 106 can include one or more monitor devices. Such monitor devices can display representations of physiological parameters. A monitor device could, for example, be used by a clinician to monitor the physiological parameters of multiple patients at one time.

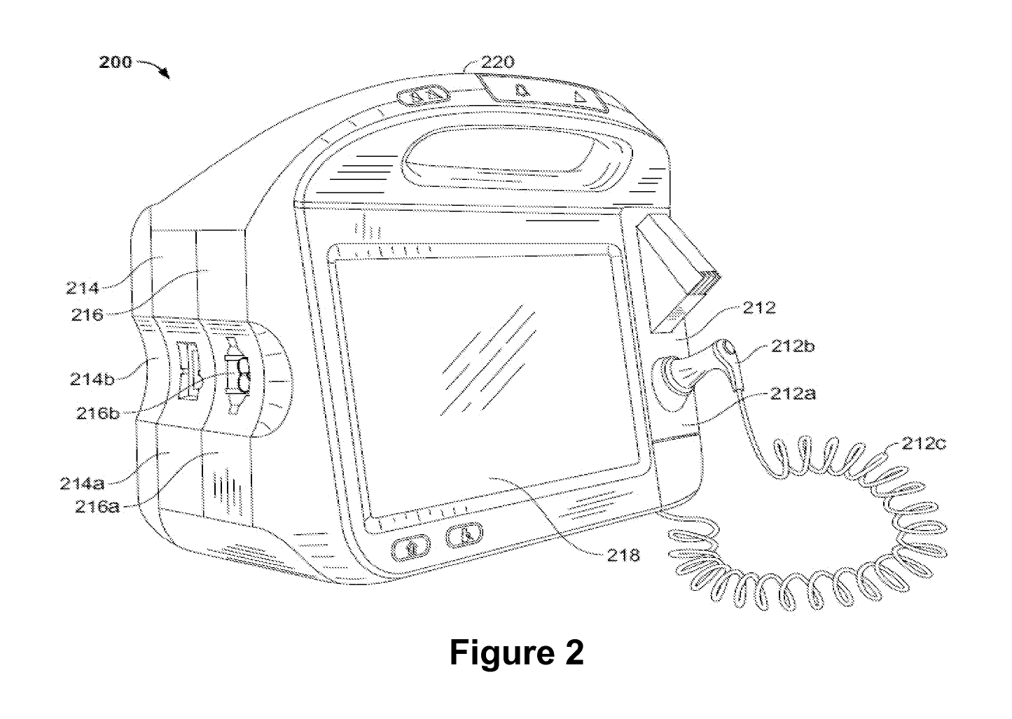

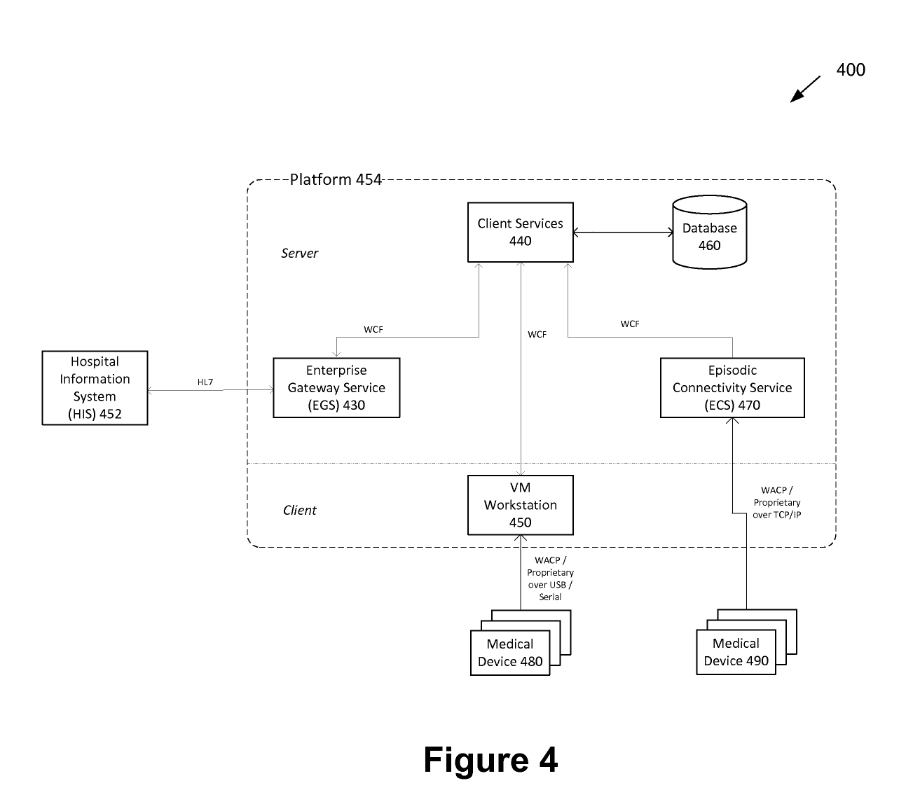

For example, in one embodiment, one or more of the client devices 106 are physiological monitor devices (see, e.g., FIG. 2) that obtain measurements from patients, as well as manipulate, store, display and forward/receive data associated with the measurements. In another embodiment, one or more of the client devices can be workstation devices (see, e.g., FIG. 4) that manipulate, store, display, and forward/receive physiological data. In such examples, the workstation devices can be located at the point of care or in a central location, such as a central monitoring station. The workstation devices can obtain data from one or more physiological monitor devices and/or other data repositories, such as records from an EMR. The workstation devices can also manipulate and display the data using one or more graphical user interfaces installed upon the workstation devices. As used herein, the phrase “client device(s)” encompasses both physiological monitor devices and workstation devices.

The client devices 106 can communicate with each other through the network 108. In various embodiments, the client devices 106 can communicate various types of data with each other through the network 108. For example, in embodiments where the set of client devices 106 includes a set of physiological monitor devices and a monitor device, each of the physiological monitor devices can send data representing measurements of physiological parameters of patients to the monitor device. In this way, the monitor device can display representations of physiological parameters to a clinician.

The interface system 104 is a computing system that acts as an interface between the EMR system 102 and the client devices 106. Different EMR systems have different software interfaces. For example, the EMR systems used by two different hospitals can have two different software interfaces. Accordingly, computing devices may need to execute different software instructions to communicate directly with different EMR systems. This can increase the complexity and cost of the computing devices.

The interface system 104 provides a single software interface to each of the client devices 106. The client devices 106 send requests to software interface provided by the interface system 104. When the interface system 104 receives a request from one of the client devices 106, the interface system 104 translates the request into a request that works with the software interface provided by the EMR system 102. The interface system 104 then provides the translated request to the software interface provided by the EMR system 102. When the interface system 104 receives a response from the EMR system 102, the interface system 104 translates the response from a format of the EMR system 102 to a system understood by the client devices 106. The interface system 104 then forwards the translated response to an appropriate one of the client devices 106. In this way, the interface system 104 can help ensure that the client devices 106 do not need to execute different software instructions in order to communicate with different EMR systems.

The client devices 106 can send various types of data to the interface system 104 for storage in the EMR system 102 and can receive various types of data from the EMR system 102 through the interface system 104. For example, in some embodiments, the client devices 106 can send measurements of physiological parameters to the interface system 104 for storage in the EMR system 102. In another example, a monitor device can retrieve past measurements of physiological parameters of patients from the EMR system 102 through the interface system 104.

FIG. 2 illustrates a view of an example physiological monitor device 200. The physiological monitor device 200 is portable. The physiological monitor device 200 includes multiple health care equipment (HCE) modules. Each of the HCE modules is configured to measure one or more physiological parameters of a health-care recipient, also referred to herein as a patient. For example, one of the HCE modules can receive leads from electrodes. Such electrodes can be attached to patients in order to perform electrocardiogram (ECG) tests on the patients.

A temperature measurement module 212 is accessible from the front side of the physiological monitor device 200. A SpO2 module 214 and a non-invasive blood pressure (NIBP) module 216 are accessible from a left hand side of the physiological monitor device 200. An upper handle portion 220 enables the physiological monitor device 200 to be carried by hand.

A front side of the physiological monitor device 200 includes a display screen 218 and an outer surface of the temperature measurement module 212. The temperature measurement module 212 is designed to measure the body temperature of a patient. As used in this document, a “module” is a combination of a physical module structure which typically resides within the physiological monitor device 200 and optional peripheral components (not shown) that typically attach to and reside outside of the physiological monitor device 200.

The temperature measurement module 212 includes a front panel 212a. The front panel 212a has an outer surface that is accessible from the front side of the physiological monitor device 200. The front panel 212a provides access to a wall (not shown) storing a removable probe (not shown), also referred to as a temperature probe, that is attached to a probe handle 212b. The probe and its attached probe handle 212b are tethered to the temperature measurement module 212 via an insulated conductor 212c. The probe is designed to make physical contact with a patient in order to sense a body temperature of the patient.

A left hand side of the physiological monitor device 200 includes an outer surface of the SpO2 module 214 and an outer surface of the NIBP module 216. The SpO2 module 214 is a HCE module designed to measure oxygen content within the blood of a patient. The NIBP module 216 is a HCE module designed to measure blood pressure of a patient.

As shown, the SpO2 module 214 includes a front panel 214a. The front panel 214a includes an outer surface that is accessible from the left side of the physiological monitor device 200. The front panel 214a includes a connector 214b that enables a connection between one or more peripheral SpO2 components (not shown) and a portion of the SpO2 module 214 residing inside the physiological monitor device 200. The peripheral SpO2 components reside external to the physiological monitor device 200. The peripheral SpO2 components are configured to interoperate with the SpO2 module 214 when connected to the SpO2 module 214 via the connector 214b. In some embodiments, the peripheral SpO2 components include a clip that attaches to an appendage of a patient, such as a finger. The clip is designed to detect and measure a pulse and an oxygen content of blood flowing within the patient.

As shown, the NIBP module 216 includes a front panel 216a having an outer surface that is accessible from the left side of the physiological monitor device 200. The front panel 216a includes a connector 216b that enables a connection between one or more peripheral NIBP components (not shown) and a portion of the NIBP module 216 residing inside the physiological monitor device 200. The peripheral NIBP components reside external to the physiological monitor device 200. The peripheral NIBP components are configured to interoperate with the NIBP module 216 when connected to the NIBP module 216 via the connector 216b. In some embodiments, the peripheral NIBP components include an inflatable cuff that attaches to an appendage of a patient, such as an upper arm of the patient. The inflatable cuff is designed to measure the systolic and diastolic blood pressure of the patient, the mean arterial pressure (MAP) of the patient, and the pulse rate of blood flowing within the patient.

The physiological monitor device 200 is able to operate within one or more workflows. A workflow is a series of one or more tasks that a user of the physiological monitor device 200 performs. When the physiological monitor device 200 operates within a workflow, the physiological monitor device 200 provides functionality suitable for assisting the user in performing the workflow. When the physiological monitor device 200 operates within different workflows, the physiological monitor device 200 provides different functionality.

When the physiological monitor device 200 is manufactured, the physiological monitor device 200 is configured to be able to operate within one or more workflows. After the physiological monitor device 200 is manufactured, the physiological monitor device 200 can be reconfigured to operate within one or more additional workflows. In this way, a user can adapt the physiological monitor device 200 for use in different workflows as needed.

In various embodiments, the physiological monitor device 200 operates within various workflows. For example, in some embodiments, the physiological monitor device 200 can operate within a monitoring workflow or a non-monitoring workflow. Example types of non-monitoring workflows include, but are not limited to, a spot check workflow and a triage workflow.

In example embodiments, the names for the workflows can be defined by the user. For example, the user can rename a “triage workflow” as “ED 3 North” or any other nomenclature as desired to provide more context to the user.

When the physiological monitor device 200 is operating within the monitoring workflow, the physiological monitor device 200 obtains a series of measurements of one or more physiological parameters of a single monitored patient over a period of time. In addition, the physiological monitor device 200 displays, on the display screen 218, a monitoring workflow home screen. The monitoring workflow home screen contains a representation of a physiological parameter of the monitored patient. The representation is based on at least one measurement in the series of measurements. A representation of a physiological parameter is a visible image conveying information about the physiological parameter.

For example, when the physiological monitor device 200 is operating within the monitoring workflow, the physiological monitor device 200 can obtain a blood pressure measurement of a single patient once every ten minutes for six hours. In this example, the physiological monitor device 200 displays a monitoring workflow home screen that contains a representation of the patient's blood pressure based on a most recent one of the temperature measurements. In this way, a user of the physiological monitor device 200 can monitor the status of the patient.

When the physiological monitor device 200 is operating within a non-monitoring workflow, the physiological monitor device 200 obtains a measurement of one or more physiological parameters from each patient in a series of patients. In addition, the physiological monitor device 200 displays a non-monitoring workflow home screen on the display screen 218. The non-monitoring workflow home screen contains a representation of the physiological parameter of a given patient in the series of patients. The representation is based on the measurement of the physiological parameter of the given patient.

In one example, when the physiological monitor device 200 is operating within a spot check workflow, the physiological monitor device 200 obtains blood pressure measurements from a series of previously-identified patients. In this other example, the physiological monitor device 200 displays a spot check workflow home screen containing a blood pressure measurement of a given patient in the series of previously-identified patients. In this way, a user of the physiological monitor device 200 can perform spot checks on the blood pressures of patients who have already been admitted to a hospital. As used in this document, a patient is a previously identified patient when the physiological monitor device 200 stores information regarding the identity of the patient.

In another example, when the physiological monitor device 200 is operating within a triage workflow, the physiological monitor device 200 can obtain a single blood pressure measurement from each patient in a series of unidentified patients as the patients arrive at a hospital. In this example, the physiological monitor device 200 displays a triage workflow home screen containing representations of the patients' blood pressures based on the single blood pressure measurements of the patients. In this way, a user of the physiological monitor device 200 can perform triage on the series of unidentified patients as they arrive. As used in this document, a patient is an unidentified patient when the physiological monitor device 200 does not store information regarding the identity of the patient.

The monitoring workflow home screen is different than the non-monitoring workflow home screen. Further, as discussed below, the navigation options associated with the different workflows allows for efficient monitoring based on the environment in which the device is used. In various embodiments, the monitoring workflow home screen is different than the non-monitoring workflow home screen in various ways. For example, in some embodiments, the monitoring workflow home screen includes at least one user-selectable control that is not included in the non-monitoring workflow home screen. In other embodiments, a representation of a physiological parameter in the monitoring workflow home screen has a different size than a representation of the same physiological parameter in the non-monitoring workflow home screen.

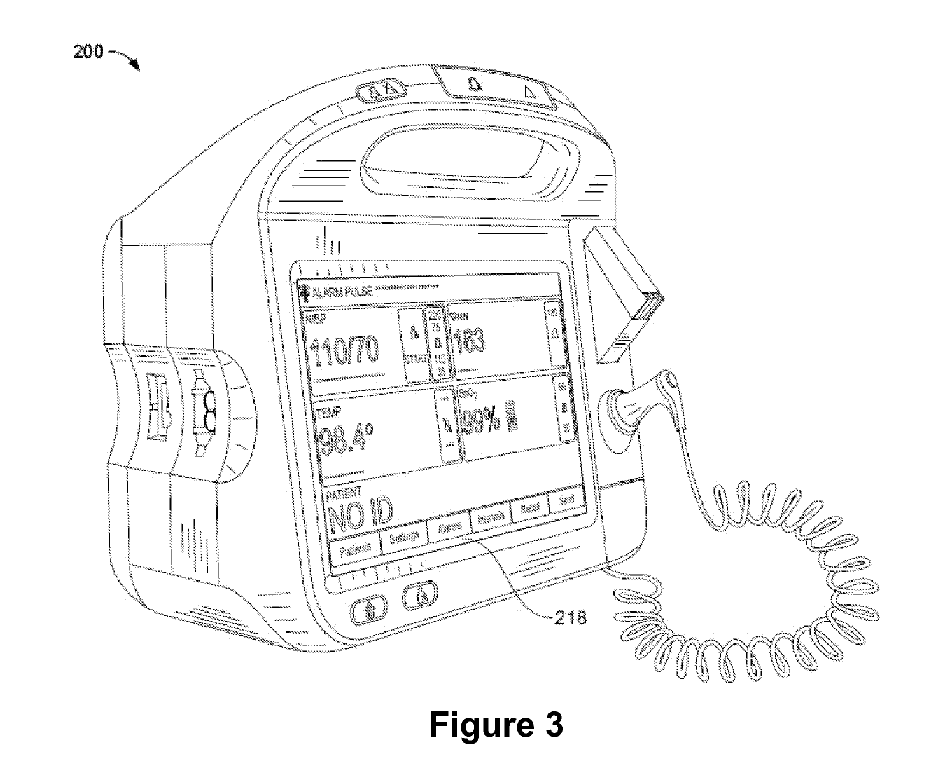

FIG. 3 illustrates an example user interface displayed on the display screen 218 of FIG. 2. The physiological monitor device 200 outputs and displays user interfaces discussed in this document on the display screen 218.

In some examples described herein, the physiological monitor device is a portable device. In other examples, the physiological monitor device is a non-portable device, such as a computing device like a workstation. Many configurations are possible.

Referring now to FIG. 4, another example system 400 for collecting measurements of physiological parameters of patients is shown. The system 400 is similar to the system 100 described above, with the following distinctions.

The system 400 is a client/server, service-oriented architecture. A platform 454 in the system 400 provides various services, including the Enterprise Gateway Service (EGS) 430, Episodic Connectivity Service (ECS) 470, and the client services 440. Devices and client applications, such as a Vital Monitoring (VM) workstation 450 access these services via a wired or wireless network connection over known protocols and interfaces, such as the Windows Communication Foundation (or WCF), which is an application programming interface (API) in the .NET Framework for building connected, service-oriented applications. Other configurations are possible.

In a typical network topology, a single server machine hosts all of the client services 440. The server also hosts a Microsoft SQL Server database 460 which provides the persistent data store for the platform 454. All database access in the platform 454 is through the client services 440.

Medical devices 480, 490 (i.e., devices that interface or interact with a patient to obtain physiological data, such as the physiological monitor device 200) can connect to the platform 454 in two ways. Devices 490 can communicate indirectly with the client services 440 via the ECS 470 which provides the infrastructure for protocol and data transformation. Alternately, medical devices 480 can connect to the VM workstation 450 via a hardwired USB or standard serial connection.

In either scenario, the devices 480, 490 can communicate through known protocols, such as the Welch Allyn Communications Protocol (WACP). WACP uses a taxonomy as a mechanism to define information and messaging. Taxonomy can be defined as description, identification, and classification of a semantic model. Taxonomy as applied to a classification scheme may be extensible. Semantic class-based modeling utilizing taxonomy can minimize the complexity of data description management by limiting, categorizing, and logically grouping information management and operational functions into families that contain both static and dynamic elements.

The EGS 430 provides connectivity between the platform 454 and external systems for transfer of patient, visit and test information. The EGS 430 interacts with the client services 440 as well as external systems. The EGS 430 supports the industry standard HL7 protocol for communicating with the external systems, such as a Hospital Information System (HIS) 452.

In this example, the VM workstation 450 is an extensible client application built on the Windows Presentation Foundation (WPF) graphical subsystem for rendering user interfaces in Windows-based applications from Microsoft Corporation of Redmond, Wash. The VM workstation 450 provides a user interface display screen for patient and test management. The VM workstation 450 allows end users to acquire, visualize, update and save diagnostic medical data. As noted, devices (e.g., medical device 480) can connect to the VM workstation 450 via USB or serial connections. Plug-ins allow test data to be imported or acquired through direct control of the connected device. Plug-ins can also provide the ability to visualize and post-process the test data.

The example ECS 470 supports wired and wireless network-based device connectivity. The ECS 470 enables medical devices 490 to connect and communicate with the platform 454 via the network infrastructure. The ECS 470 communicates with the medical devices 490, receiving requests and processing them via interaction with the client services 440. In order to support new devices, the ECS 470 consumes plug-ins for communicating with and processing data.

The example EGS 430 supports interfacing with external hospital information systems (e.g., HIS 452) for the exchange of patient and test data. Default functionality allows data to be exported through HL7 messages or file I/O. The EGS 430 consumes plug-ins which transform test and measurement data into formats expected by the external systems. The EGS 430 can also be extended to support different network communication protocols that may be required by external systems.

In this example, the client services 440 provide basic data management services for test, patient and clinician data. These services are responsible for managing the majority of the data within the platform 454. The core services also support user authentication, server administration, error logging and a publish/subscribe service.

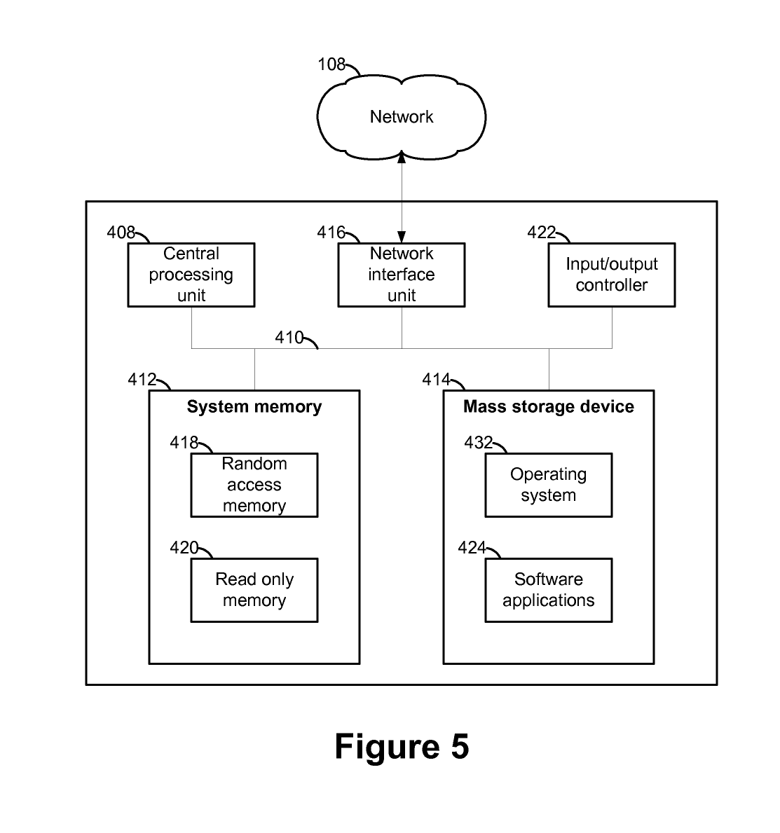

Referring now to FIG. 5, additional details of the VM workstation 450 are shown.

In this embodiment, various applications and services built on the platform 454 (e.g., VM workstation 450, ECS 470 and EGS 430) are a compilation of the components shown in FIG. 5. In this example, the architecture of the VM workstation 450 is shown.

As illustrated in the example of FIG. 5, the VM workstation 450 includes at least one central processing unit (“CPU”) 408, a system memory 412, and a system bus 410. The system bus 410 couples the system memory 412 to the CPU 408. The system memory 412 includes a random access memory (“RAM”) 418 and a read-only memory (“ROM”) 420. The ROM 420 stores a basic input/output system (BIOS). The BIOS contains the basic routines that help to transfer information between elements within the VM workstation 450, such as during startup. The VM workstation 450 further includes a mass storage device 414. The mass storage device 414 is able to store computer-executable software instructions and data.

The mass storage device 414 is connected to the CPU 408 through a mass storage controller (not shown) connected to the bus 410. The mass storage device 414 and its associated computer-readable data storage media provide non-volatile, non-transitory storage for the VM workstation 450. Although the description of computer-readable data storage media contained herein refers to a mass storage device, such as a hard disk or CD-ROM drive, readers should appreciate that computer-readable data storage media can be any available non-transitory, physical device or article of manufacture from which the VM workstation 450 can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the VM workstation 450.

In various embodiments, the VM workstation 450 may operate in a networked environment using logical connections to remote network devices through the network 108, such as a local network, the Internet, or another type of network. The VM workstation 450 connects to the network 108 through a network interface unit 416 connected to the bus 410. Readers will appreciate that the network interface unit 416 may also be utilized to connect to other types of networks and remote computing systems. The VM workstation 450 also includes an input/output controller 422 for receiving and processing input from a number of other devices, including a keyboard, a mouse, a touch user interface display screen, or another type of input device. Similarly, the input/output controller 422 may provide output to a touch user interface display screen, a printer, or other type of output device.

As mentioned briefly above, the mass storage device 414 and the RAM 418 of the VM workstation 450 can store software instructions and data. The software instructions include an operating system 432 suitable for controlling the operation of the VM workstation 450. The mass storage device 414 and/or the RAM 418 also store software instructions, that when executed by the CPU 408, cause the VM workstation 450 to provide the functionality of the VM workstation 450 discussed in this document. For example, the mass storage device 414 and/or the RAM 418 can store software instructions that, when executed by the CPU 408, configure the VM workstation 450 such that the VM workstation 450 displays a particular user interface.

Although components of the VM workstation 450 are depicted in FIG. 5, other devices, such as the medical devices 200, 480, 490, can include similar components.

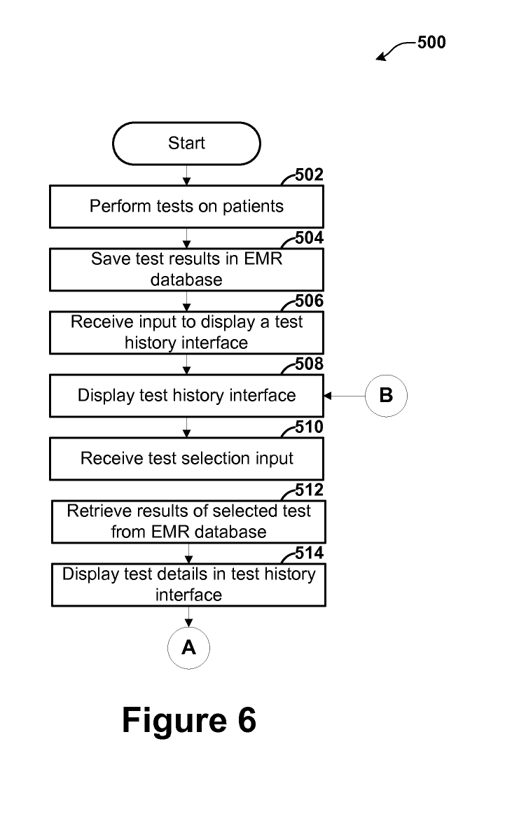

FIG. 6 is a flowchart illustrating an example operation 500 of a client device, such as the VM workstation 450. The operation 500 facilitates review of results of tests, such as ECG tests. As illustrated in the example of FIG. 6, the VM workstation 450 performs tests on one or more patients (502). In various embodiments, the VM workstation 450 can perform various tests on the patients. For example, the VM workstation 450 can perform ECG tests on the patients. In another example, the VM workstation 450 can perform electroencephalogram (EEG) tests on the patients.

After performing the tests on one of more of the patients, the VM workstation 450 saves the results of the tests to the EMR database 110 (504). To save the test results to the EMR database 110 the VM workstation 450 communicates with one or more other devices, such as the interface system 104, as discussed above.

At some time after the VM workstation 450 saves the test results to the EMR database 110 or other test results are saved to the EMR database 110, the VM workstation 450 receives input from a user to display a test history interface (506). In various embodiments, the VM workstation 450 receives the input to display the test history interface in various ways. For example, the VM workstation 450 can receive the input to display the test history interface when the user selects an onscreen control.

In response to receiving the input to display the test history interface, the VM workstation 450 displays the test history interface (508). The test history interface contains information regarding test results stored in the EMR database 110. For example, the test history interface can contain parameters of a patient's ECG test, a waveform of the ECG test, text regarding a user's interpretation of the ECG test, users' comments on the ECG test, and other types of information about one or more ECG tests. In various embodiments, the test history interface can have various appearances.

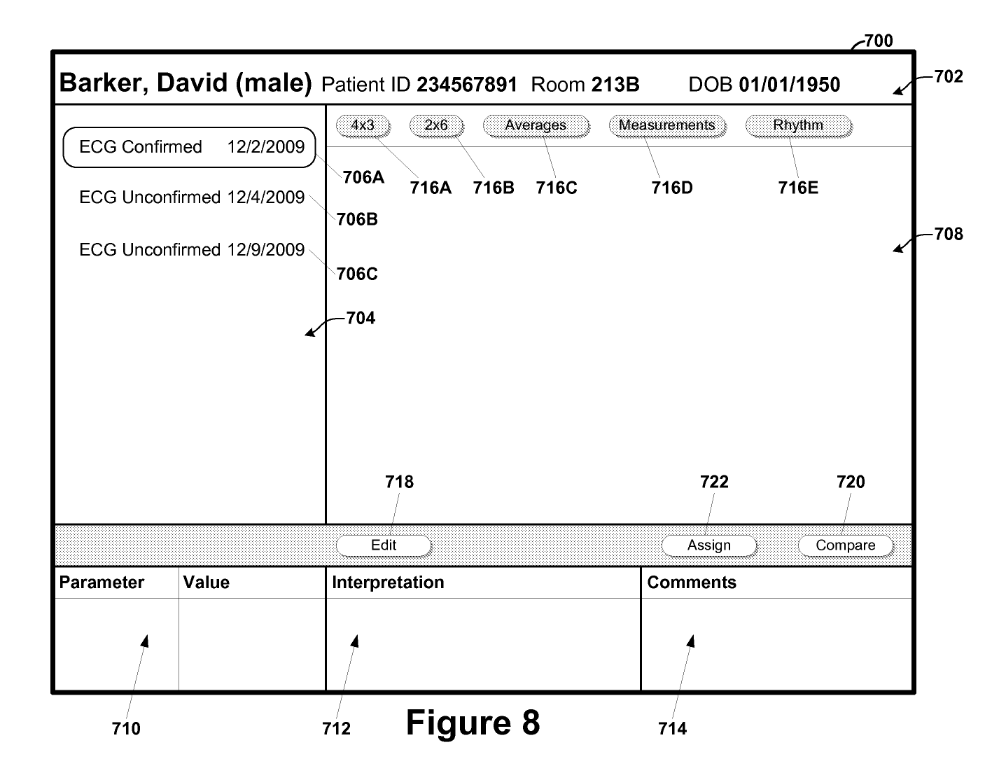

FIG. 8 is a screen illustration of an example test history interface 700. The test history interface 700 contains information regarding tests performed on an individual patient. Other test history interfaces can include information regarding various other tests.

For example, the VM workstation 450 can display a search interface. In this example, the search interface can include one or more criterion entry features, such as textboxes, drop boxes, text areas, checkboxes, radio buttons, and other data entry controls. In this example, the VM workstation 450 receives input of one or more search criteria in the one or more criteria entry features. Such search criteria can include test type, confirmation status, assigned clinician, patient name or identifier, date range, and so on. In this example, the test history interface lists tests that satisfy the one or more user-entered search criteria.

The test history interface 700 contains a patient identification area 702. The patient identification area 702 contains information identifying a given patient. The test history interface 700 contains information regarding the test results of the given patient. In the example of FIG. 8, the patient identification area 702 specifies that the given patient's name is “Barker, David,” that the given patient's patient identifier is “234567891,” that the given patient's room is “213B,” and that the given patient's date of birth is “01/01/1950.”

In addition, the test history interface 700 includes a test list area 704. The test list area 704 contains test items 706A-706C (collectively, “test items 706”). Each of the test items 706 corresponds to a test performed on the given patient. For instance, in the example of FIG. 8, the test item 706A corresponds to an ECG test performed on Dec. 2, 2009, the test item 706B corresponds to an ECG test performed in Dec. 4, 2009, and the test item 706C corresponds to an ECG test performed on Dec. 9, 2009.

The test history interface 700 also includes a details area 708, a parameters area 710, an interpretation area 712, and a comments area 714. In some embodiments, the user can collapse the test list area 704 to expand the size of the details area 708. Furthermore, in some embodiments, the user can collapse the parameters area 710, the interpretation area 712, and the comments area 714 to expand the size of the details area 708.

The details area 708 displays information about a selected one of the given patient's tests. The details area 708 displays information about the selected test in the form of one or more reports. For instance, the details area 708 includes report controls 716A-714E (collectively, “report controls 716”). When the user selects one of the report controls 716, the details area 708 displays a type of report corresponding to the selected report control. Hence, if the details area 708 initially contains a report corresponding to the report control 716A, the user can select the report control 706B to cause the details area 708 to display a corresponding report. The user can then cause the details area 708 to display the report corresponding to the report control 716A again by selecting the report control 716A.

In the example of FIG. 8, the report control 716A corresponds to a 4×3 report, the report control 716B corresponds to a 2×6 report, the report control 716C corresponds to an averages report, the report control 716D corresponds to a measurements report, and the report control 716E corresponds to a rhythm report. The 4×3 report, the 2×6 report, the averages report, the measurements report, and the rhythm report are applicable to ECG tests.

A 4×3 report displays signals from leads that connect the physiological monitor device 200 to twelve electrodes. In the 4×3 report the signals are displayed in matrix having four cells. Each of the cells includes signals from three leads. Below this matrix is a signal from a lead that spans the entire width of the recording. The typical width of the recording is ten seconds in duration. The four groups are either timed sequentially or simultaneously, depending on a setting.

A 2×6 report displays signals from twelve leads. These signals are grouped in two groups of six leads. Each group is allocated half of the available width of the details area 708. The two groups are timed either sequentially or simultaneously, depending on a setting.

An averages report displays an averaged beat constructed from raw recording data. The signals from twelve leads are displayed in a 4×3 matrix.

A measurements report displays lead-specific measurements. Both the amplitudes and durations of each of the QRS complex subparts (Q, R, S, R′, S′, R″ waves) as well as isoelectric segments (I, K), ST levels and P and T wave positive and negative amplitudes.

A rhythm report displays signals from twelve leads. The signals are displayed in separate groups of either three or six leads simultaneously drawn on the display screen over an entire duration of the ECG test.

In some embodiments, the user can configure various parameters that control various aspects of the details area 708. For example, the user can set a parameter that controls whether groups of leads in the details area 708 represent sequential stretches of an ECG or represent the same simultaneous subsection of the ECG. In another example, the user can select a chart speed parameter. The chart speed parameter defines the x-axis scale of the ECG versus the background grid. In this example, the chart speed can be selectable from 25 to 55 mm/s. In yet another example, the user can set a sensitivity parameter. The sensitivity parameter defines the y-axis scale of the ECG versus the background grid. In this example, the user can set the sensitivity parameter from 5, 10, and 20 mm/mV. In yet another example, the user can set an amplitude unit parameter. The amplitude unit parameter specifies the units of measurement for ECG amplitudes. In this example, the user can select mm or μV for the amplitude unit parameter. In yet another example, the details area 708 can include controls to turn on or off filters, such as an AC filter, a muscle filter, a baseline filter, and a pacemaker filter. Furthermore, the details area 708 can include additional controls that help the user perform various tasks. For example, the details area can include a scroll control, a measurement control, a copy control, a print control, a zoom in control, a zoom out control, and/or other controls.

The parameters area 710 displays names of parameters of the selected test and the values of the parameters. For example, if the selected test is an ECG test, the parameters area 710 can display values for a date and time of the ECG test, the given patient's blood pressure at a time that the ECG test was performed, the given patient's pulse rate at the time that the ECG test was performed, a PVPQ value resulting from the ECG test, a QRS value resulting from the ECG test, a QT/QTc value resulting from the ECG test, and a P/QRS/T axis value resulting from the ECG test.

The interpretation area 712 contains text describing a physician's interpretation of the selected test. For example, if the selected test is an ECG test, the interpretation area 712 can contain text indicating that a physician believes that the ECG test shows the given patient's heart function is normal or diseased. In addition, the interpretation area 712 can include data indicating whether the physician's interpretation of the selected test has been confirmed by another physician. For example, the interpretation area 712 can include text stating that the interpretation shown in the interpretation area 712 was confirmed by a particular physician.

The comments area 714 contains text or other information representing a user's comments regarding the selected test. In some instances, the comments area 714 can contain the comments entered by a nurse or a physician's assistant. The comments are not intended to be definitive interpretations of the selected test.

Continuing reference is now made to the example of FIG. 6. During the time that the VM workstation 450 displays the test history interface on the display screen, the VM workstation 450 receives test selection input from the user (510). The test selection input indicates a selection by the user of one of the given user's tests. In various embodiments, the VM workstation 450 can receive the test selection input in various ways. For instance, in the example of FIG. 8, the VM workstation 450 receives test selection input when the user selects one of the test items 706. In the example of FIG. 8, the user has selected the test item 706A. Accordingly, the test item 706A is visually differentiated from the non-selected test items 706B and 706C.

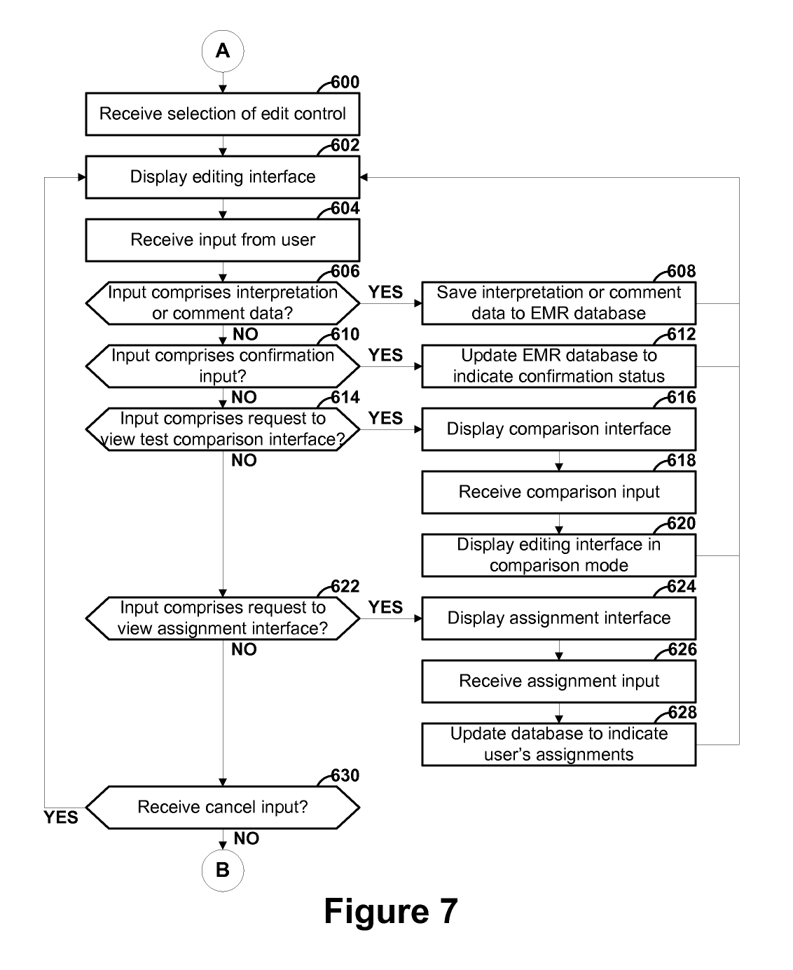

In response to receiving the test selection input, the VM workstation 450 retrieves results of the selected test from the EMR database 110 (512). The VM workstation 450 then displays details regarding the selected test in the test history interface (514). In various embodiments, the test history interface display various details about the selected test. For instance, in the example of FIG. 8, the user has selected an ECG test. Accordingly, the details area 708 displays one or more waveforms resulting from the ECG test. After the VM workstation 450 displays the details regarding the selected test, the VM workstation 450 performs the portion of the operation 500 illustrated in the example of FIG. 7.

Reference is now made to the portion of the operation 500 illustrated in the example of FIG. 7. During the time that the VM workstation 450 displays the selected test's details in the test history interface, the VM workstation 450 can receive a selection of an edit control in the test history interface (600). For instance, the VM workstation 450 can receive a selection by the user of an edit control 718 in the test history interface 700 (FIG. 8).

In response to receiving the selection of the edit control, the VM workstation 450 displays an editing interface on the display screen (602). The edit interface includes controls that enable authorized users to enter an interpretation of the selected test, confirm another physician's interpretation of the selected test, provide comments regarding the selected test, and otherwise edit details regarding the selected test. In various embodiments, the editing interface includes various features and has various appearances.

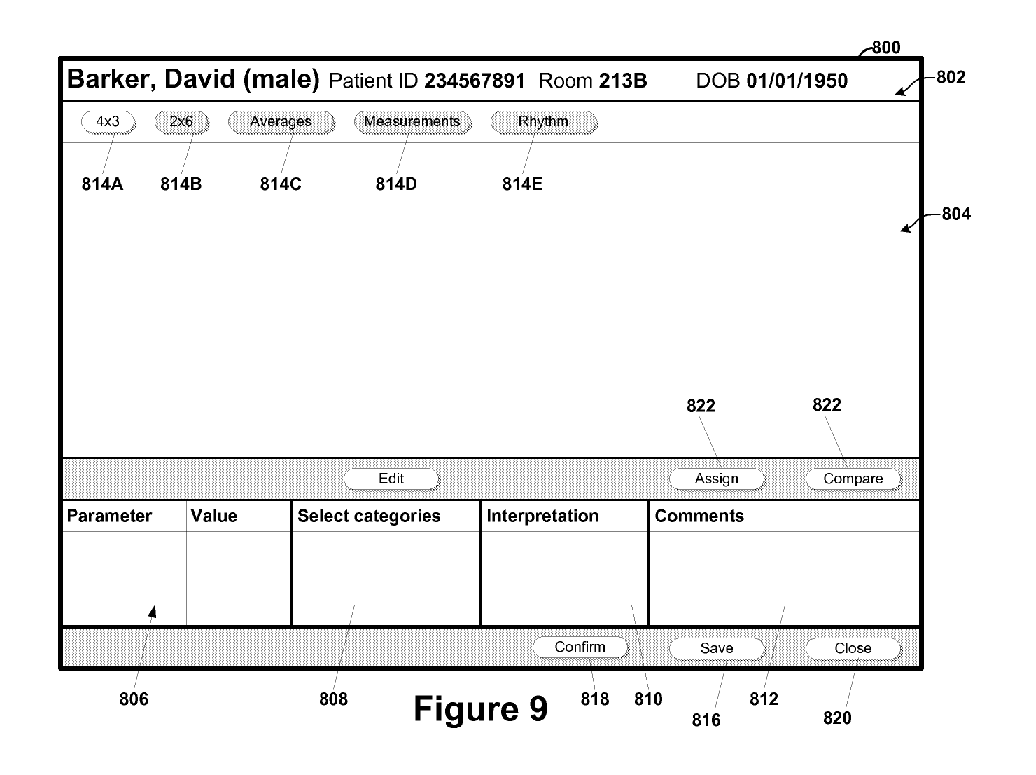

FIG. 9 is a screen illustration of an example editing interface 800. The editing interface 800 includes a patient identification area 802, a details area 804, a parameters area 806, a category selection area 808, an interpretation area 810, and a comments area 812. Like the patient identification area 702 in the test history interface 700, the patient identification area 802 includes data that identifies the given patient. The details area 804 shows details of the selected test. The details area 804 includes report controls 814A-E (collectively, “report controls 814”). Like the report controls 716 in the test history interface 700, the user can select different ones of the report controls 814 to instruct the VM workstation 450 to display different data regarding the selected test in the details area 804. Furthermore, in some embodiments, the user can increase the size of the details area 804 by decreasing the size of or collapsing the parameters area 806, the category selection area 808, the interpretation area 810, and the comments area 812.

Reference is now made again to the example of FIG. 7. During the time that the VM workstation 450 displays the editing interface on the display screen, the VM workstation 450 receives input from the user (604). The input can instruct the VM workstation 450 to perform various functions. Accordingly, the VM workstation 450 performs actions to determine what functions the input is requesting the VM workstation 450 to perform.

Accordingly, after receiving the input from the user, the VM workstation 450 determines whether the received input is interpretation or comment data (606). The interpretation data indicates the user's interpretation of the results of the selected test. The comment data indicates the user's comments regarding the selected test. If the received input comprises interpretation and/or comment data (“YES” of 606), the VM workstation 450 communicates with one or more other devices to save the interpretation and/or comment data to the EMR database 110 (608). After the VM workstation 450 saves the interpretation and/or comment data to the EMR database 110, the VM workstation 450 continues to display the editing interface (602) and can receive additional input. Other embodiments display the test history interface after saving the interpretation and/or comment data to the EMR database 110.

In various embodiments, the VM workstation 450 receives input comprising interpretation data and/or comment data in various ways. In the example of FIG. 9, the VM workstation 450 receives interpretation data when the user inputs text into the interpretation area 810. For example, if the selected test is an ECG test, the user can enter text indicating that it is the user's interpretation of the results of the ECG test that the given patient's heart rhythm is normal.

Furthermore, the VM workstation 450 can receive interpretation data when the user selects one or more category controls in the category selection area 808. Each of the category controls corresponds to a different interpretation of the selected test. For example, if the selected test is an ECG test, the category controls in the category selection area 808 can include a “normal rhythm” category control, a “sinus arrhythmia” category control, a “supravenincular arrhythmia” category control, a “sinus tachycardia” control, a “sinus brachycardia” control, and so on. When the user selects one or more of category controls in the category selection area 808, the VM workstation 450 can display text describing the interpretation corresponding to the selected category control in the interpretation area 810.

In the example of FIG. 9, the VM workstation 450 receives input comprising comment data when the user enters text in the comments area 812. For example, the VM workstation 450 can receive the comment data when the user selects the comments area 812 and then provides textual input to the VM workstation 450.

The editing interface 800 includes a save control 816. When the user has finished providing interpretation and/or comment data to the VM workstation 450, the user can select the save control 816. The VM workstation 450 saves the interpretation and/or comment data to the EMR database 110 in response to receiving the user's selection of the save control 816. In other embodiments, the VM workstation 450 saves the interpretation and/or comment data to the EMR database 110 in response to other events.

Reference is now made again to the example of FIG. 7. If the received input did not comprise interpretation or comment data (“NO” of 606), the VM workstation 450 determines whether the received input comprises confirmation input (610). Confirmation input indicates that the user has updated a confirmation status of another user's interpretation of the selected test. For instance, confirmation input can indicate that the user has confirmed or unconfirmed another user's interpretation of the selected test.

If the received input comprises confirmation input (“YES” of 610), the VM workstation 450 communicates with one or more other devices to update the EMR database 110 to indicate that the confirmation status indicated by the confirmation input (612). After updating the EMR database 110, the VM workstation 450 displays the editing interface again (602) and can receive further input. Other embodiments display the test history interface or other interfaces after updating the EMR database 110.

In various embodiments, the VM workstation 450 receives the confirmation input in various ways. In the example of FIG. 9, the editing interface 800 includes a confirmation control 818. The VM workstation 450 receives the confirmation input when the user selects the confirmation control 818.

Continuing reference is now made again to the example of FIG. 7. If the received input is not confirmation input (“NO” of 610), the VM workstation 450 determines whether the received input comprises a request to view a test comparison interface (614). In various embodiments, the VM workstation 450 can receive a request to view the test comparison interface in various ways. For instance, in the example of FIG. 9, the editing interface 800 includes a compare control 822. The VM workstation 450 receives input to view the test comparison interface when the user selects the compare control 822. In some embodiments, the user can also request to view the test comparison interface in order to compare test results in the test history interface. For instance, the user can request to view the test comparison interface by selecting a compare control 720 in the test history interface 700.

If the received input is a request to view the test comparison interface (“YES” of 614), the VM workstation 450 displays the test comparison interface (616). The test comparison interface includes controls that enable the user to select a test for comparison against the selected test. For example, the comparison interface can contain a list of tests available to be compared against the selected test. During a time that the VM workstation 450 displays the test comparison interface, the VM workstation 450 receives comparison input (618). The comparison input indicates a test for comparison against the selected test (i.e., a reference test).

In response to receiving the comparison input, the VM workstation 450 displays the editing interface in a test comparison mode (620). When the VM workstation 450 displays the editing interface in the test comparison mode, the editing interface concurrently contains details or reports of the selected test and the reference test. In this way, the user can compare the selected test and the reference test. Comparing the selected test to other tests can assist the user in interpreting the selected test, confirming another user's interpretation of the selected test, or in making comments regarding the selected test.

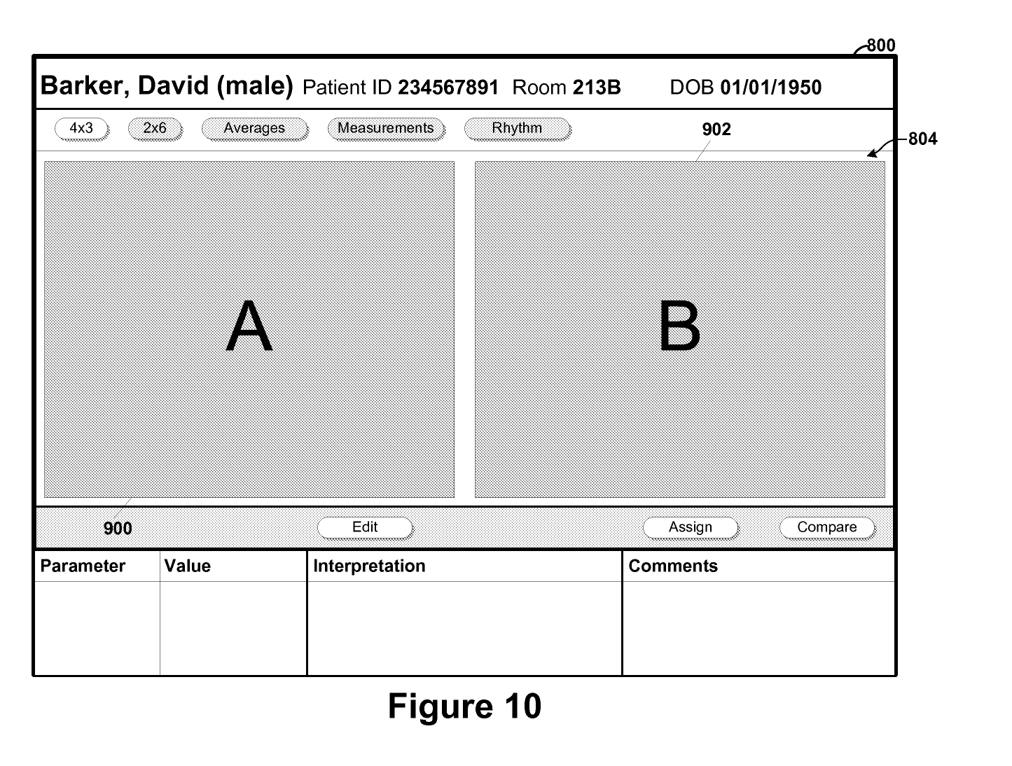

In various embodiments, the editing interface can have various appearances when the editing interface is in the test comparison mode. FIG. 10 is a screen illustration of the example editing interface 800 in the test comparison mode. As illustrated in the example of FIG. 10, the details area 804 of the editing interface 800 includes an area 900 and an area 902. The area 900 contains details regarding the selected test. The area 902 contains details regarding the reference test. For example, if the selected test and the reference test are ECG tests, the area 900 can include a first graph and the area 902 can include a second graph. In this example, the first graph represents a waveform of the selected test and the second graph represents a waveform of the reference test. In the example of FIG. 10, the area 900 and the area 902 are side-by-side. In other instances, the area 900 and the area 902 can be stacked vertically such that the area 900 is above the area 902 or vice versa.

Continuing reference is now made again to the example of FIG. 7. If the received input does not comprise a request to view a comparison interface (“NO” of 614), the VM workstation 450 determines whether the received input comprises a request to view a test assignment interface (622). In various embodiments, the VM workstation 450 can receive a request to view the test assignment interface in various ways. For instance, in the example of FIG. 9, the editing interface includes an assign control 824. The VM workstation 450 receives a request to view the test assignment interface when the user selects the assign control 824. In some embodiments, the user can also access the assignment interface from the test history interface. For example, the user can access the assignment interface by selecting an assign control 722 in the test history interface 700 (FIG. 8).

If the received input is a request to view the test assignment interface (“YES” of 622), the VM workstation 450 displays the test assignment interface on the display screen (624). The test assignment interface includes controls that enable the user to assign tasks of interpreting tests or confirming interpretations of tests to users.

During the time that the display screen displays the test assignment interface, the VM workstation 450 can receive assignment input from the user (626). The assignment input indicates that the user has assigned at least one test to a given user for interpretation or confirmation. After receiving the assignment input from the user, the VM workstation 450 communicates with one or more other devices to update the EMR database 110 to indicate the user's assignment of tests to users for interpretation or confirmation (628). After updating the EMR database 110, the VM workstation 450 displays the editing interface again (602) and can receive additional input. Other embodiments of the VM workstation 450 display the test history interface, continue displaying the test assignment interface, or display another interface after updating the EMR database 110.

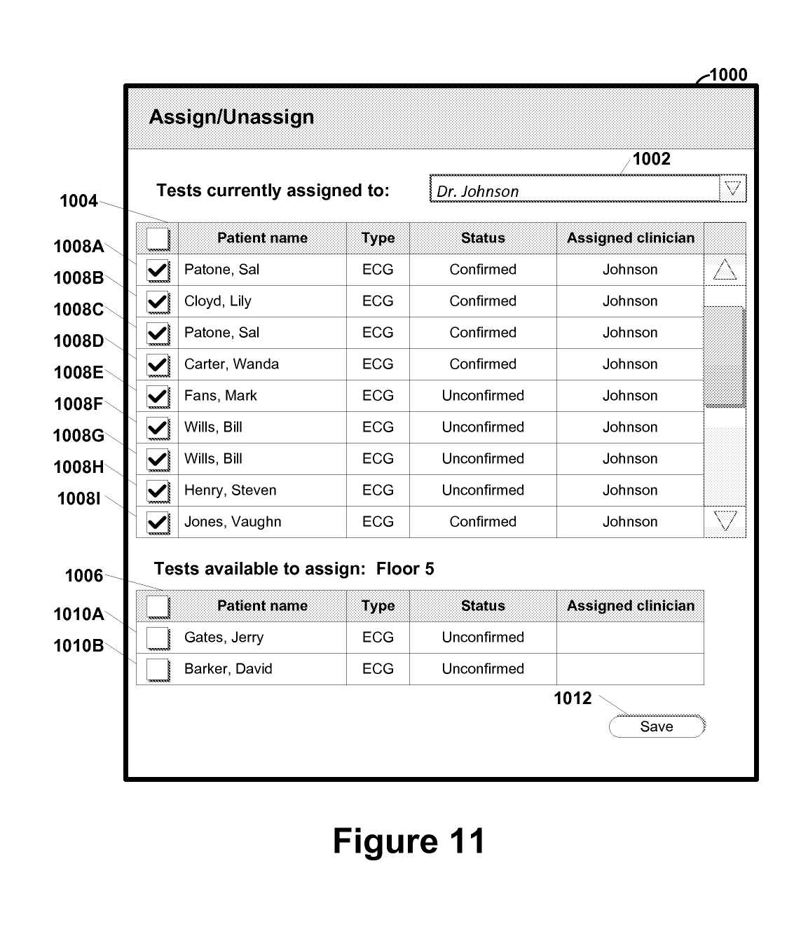

Various embodiments display various assignment interfaces and receive assignment input in various ways. FIG. 11 is a screen illustration of an example test assignment interface 1000. The test assignment interface 1000 includes an assignee selection control 1002, an assigned tests area 1004, and an available tests area 1006.

The assignee selection control 1002 is a drop-down box. When the user selects the assignee selection control 1002, the VM workstation 450 displays a list of potential assignees. In some instances, the potentially assignees are physicians authorized to interpret test results or confirm interpretations of test results. The user can select a given assignee from the displayed list of potential assignees. In the example of FIG. 11, the user has selected the assignee “Dr. Johnson.”

In response to the user selecting an assignee, the VM workstation 450 updates the assigned tests area 1004 to display a list of test items 1008A-J (collectively, “test items 1008”). Each of the test items 1008 corresponds to a test currently assigned to the selected assignee. Each of the test items 1008 includes a checkbox. When the user selects the assignee, each of the checkboxes is initially in a checked state. The user un-assigns a particular test from the selected assignee by selecting the checkbox corresponding to the particular test. For example, to un-assign the test corresponding to the test item 1008A, the user selects the checkbox in the test item 1008A. Selecting a checkbox when the checkbox is in a checked state causes the checkbox to enter an unchecked state.

The available tests area 1006 includes a list of test items 1010A-B (collectively, “test items 1010”). The test items 1010 correspond to tests that are not assigned to a user for interpretation or confirmation. Each of the test items 1010 includes a checkbox. When the VM workstation 450 initially displays the test assignment interface 1000, the checkboxes in the test items 1010 are in unchecked states. To assign tests corresponding to the test items 1010 to the selected user, the user selects the checkboxes in the test item 1010. For example, to assign the test corresponding to the test item 1010A to the selected user, the user selects the checkbox in the test item 1010A. Selecting a checkbox when the checkbox is in an unchecked state causes the checkbox to enter the checked state.

The test assignment interface also includes a save control 1012. When the user selects the save control 1012, the VM workstation 450 updates the EMR database 110 to indicate the user's assignments of tests.

Continuing reference is now made again to the example of FIG. 7. If the received input does not comprise a request to view the assignment interface (“NO” of 622), the VM workstation 450 determines whether the received input comprises cancellation input (630). The cancellation input indicates that the user wants to return from the editing interface to the test history interface. Accordingly, if the received input is cancellation input (“YES” of 630), the VM workstation 450 displays the test history interface again (508). Otherwise, if the received input is not cancellation input (“NO” of 630), the VM workstation 450 continues to display the editing interface (602) and can receive additional input. Various embodiments receive cancellation input in various ways. In the example of FIG. 9, the editing interface 800 includes a close control 820. The VM workstation 450 receives the cancellation input when the user selects the close control 820.

Although the functionality and interfaces shown in FIGS. 6-11 are described in reference to the VM workstation 450, the medical devices 200, 480, 490 can include similar functionality and/or interfaces.

The various embodiments described above are provided by way of illustration only and should not be construed as limiting. Those skilled in the art will readily recognize various modifications and changes that may be made without following the example embodiments and applications illustrated and described herein. For example, the operations shown in the figures are merely examples. In various embodiments, similar operations can include more or fewer steps than those shown in the figures. Furthermore, in other embodiments, similar operations can include the steps of the operations shown in the figures in different orders. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for facilitating review of results of electrocardiogram (ECG) tests, the method comprising:
displaying a test history interface on a display screen of a client device, the test history interface listing at least some ECG tests;
receiving, by the client device, a selection of a given ECG test during a time that the display screen displays the test history interface, the given ECG test being among the ECG tests listed in the test history interface;
communicating, by the client device, with the one or more other devices to retrieve results of the given ECG test from an Electronic Medical Record (EMR) database; and
displaying the results of the given ECG test in the test history interface in response to receiving the selection of the given ECG test.

2. The method of claim 1, further comprising: displaying a first user's interpretation of the given ECG test in the test history interface after the client device receives the selection of the given ECG test.

3. The method of claim 2, further comprising:
receiving interpretation input at the client device, the interpretation input indicating the first user's interpretation of the given ECG test; and
communicating with the one or more other devices to save the first user's interpretation of the given ECG test to the EMR database.

4. The method of claim 3, further comprising:
receiving comment data at the client device, the comment data indicating comments on the given ECG test by the first user or another user;
communicating with the one or more other devices to save the comments on the given ECG test in the EMR database; and
displaying the comments on the given ECG test in the test history interface after receiving the selection of the given ECG test.

5. The method of claim 4,
wherein displaying the test history interface comprises concurrently displaying a details area, a parameters area, an interpretation area, and a comments area, the details area containing a report on the results of the given ECG test, the parameters area containing parameter names and values for the given ECG test, the interpretation area containing the first user's interpretation of the given ECG test, the comments area containing the comments on the given ECG test; and
wherein the method further comprises collapsing the parameters area, the interpretation area and the comments area to expand the details area in response to input from a current user of the client device.

6. The method of claim 2, further comprising:
receiving confirmation data at the client device, the confirmation data indicating that a second user confirmed the first user's interpretation of the given ECG test;
communicating with the one or more other devices to store data in the EMR database indicating that the second user confirmed the first user's interpretation of the given ECG test; and
during a time that the test history interface displays the results of the given ECG test, indicating in the test history interface that the first user's interpretation of the given ECG test has been confirmed.

7. The method of claim 6, wherein the method further comprises:
displaying an assignment interface on the display screen of the client device;
receiving a first assignment input during a time that the display screen displays the assignment interface, the first assignment input assigning a task of interpreting the given ECG test to the first user; and
receiving a second assignment input during the time that the display screen displays the assignment interface, the second assignment input assigning a task of confirming the first user's interpretation of the given ECG test to the second user.

8. The method of claim 1,
wherein the method further comprises:
displaying a search interface on the display screen of the client device, the search interface including a criterion entry feature; and
receiving, from a user, input of a search criterion in the criterion entry feature; and
wherein each of the ECG tests listed in the test history interface satisfy the search criterion.

9. The method of claim 1,
wherein displaying the test history interface comprises displaying a first report selection control and a second report selection control in the test history interface; and
wherein displaying the results of the given ECG test comprises:
displaying a first report on the results of the given ECG test in the test history interface;
receiving a first input at the client device, the first input indicating a selection of the second report selection control;
in response to receiving the first input, displaying a second report on the results of the given ECG test in the test history interface instead of the first report;
receiving a second input at the client device during a time that the display screen displays the second report in the test history interface, the second input indicating a selection of the first report selection control;
in response to receiving the second input, displaying the first report in the test history interface instead of the second report.

10. The method of claim 9, wherein the first report and the second report are different ones of the following report types: 4×3 reports, 2×6 reports, averages reports, measurement reports, and rhythm reports.

11. The method of claim 1,
wherein displaying results of the given ECG test comprises displaying a first report on the results of the given ECG test in the test history interface;
during a time that the display screen displays the first report in the test history interface, receiving a request to view a test comparison interface;
displaying the test comparison interface on the display screen in response to receiving the request to view the test comparison interface, the test comparison interface including controls for selection of a test for comparison against the given ECG test;
receiving, by the client device, comparison input during at time that the display screen displays the test comparison interface, the comparison input indicating a reference test; and
in response to receiving the comparison input, concurrently displaying the first report and a second report in the test history interface, the second report containing details of the reference test.

12. The method of claim 1, wherein communicating with the one or more other devices comprises sending, by the client device, requests to an interface system that translates the requests into requests that work with a software interface provided by an EMR system.

13. The method of claim 1, wherein performing the ECG tests comprises receiving, at the client device, signals from electrodes attached to the one or more patients.

14. A physiological monitor device comprising:
a display screen;
a health care equipment (HCE) module configured to receive signals from electrodes;
one or more computer storage media that store computer-executable instructions; and
a processing unit that accesses the computer-executable instructions and executes the computer-executable instructions, execution of the computer-executable instructions configuring the physiological monitor device such that the physiological monitor device:
performs a plurality of electrocardiogram (ECG) tests on one or more patients using the signals received from the electrodes;
communicates with one or more other devices to store results of the ECG tests in an Electronic Medical Record (EMR) database associated with an EMR system;
displays a test history interface on the display screen, the test history interface listing at least some of the ECG tests;
receives a selection of a given ECG test during a time that the display screen displays the test history interface, the given ECG test being among the ECG tests listed in the test history interface;
communicates with the one or more other devices to receive results of the given ECG test from the EMR database; and
displays the results of the given ECG test in the test history interface in response to receiving the selection of the given ECG test.

15. The physiological monitor device of claim 14, wherein execution of the computer-executable instructions by the processing unit further configures the physiological monitor device such that the physiological monitor device:
receives interpretation input at the physiological monitor device, the interpretation input indicating a first user's interpretation of the given ECG test;
communicates with the one or more other devices to save the first user's interpretation of the given ECG test to the EMR database; and
displays the first user's interpretation of the given ECG test in the test history interface after the physiological monitor device receives the selection of the given ECG test.

16. The physiological monitor device of claim 15, wherein execution of the computer-executable instructions by the processing unit further configures the physiological monitor device such that the physiological monitor device:
receives comment input that indicates comments on the given ECG test by the first user or another user;
communicates with the one or more other devices to save the comments on the given ECG test in the EMR database; and
displays the comments on the given ECG test in the test history interface after receiving the selection of the given ECG test.

17. The physiological monitor device of claim 16, wherein execution of the computer-executable instructions by the processing unit further configures the physiological monitor device such that the physiological monitor device:
receives confirmation input that indicates that a second user confirmed the first user's interpretation of the given ECG test;
communicates with the one or more other devices to store data in the EMR database indicating that the second user confirmed the first user's interpretation of the given ECG test; and
during a time that the test history interface displays the results of the given ECG test, indicates in the test history interface that the first user's interpretation of the given ECG test has been confirmed.

18. The physiological monitor device of claim 17, wherein execution of the computer-executable instructions by the processing unit further configures the physiological monitor device such that the physiological monitor device:
displays an assignment interface on the display screen;
receives a first assignment input during a time that the display screen displays the assignment interface, the first assignment input assigning a task of interpreting the given ECG test to the first user; and
receives a second assignment input during the time that the display screen displays the assignment interface, the second assignment input assigning a task of confirming the first user's interpretation of the given ECG test to the second user.

19. The physiological monitor device of claim 14,
wherein the display screen displays a first report on the results of the given ECG test in the test history interface; and
wherein execution of the computer-executable instructions by the processing unit further configures the physiological monitor device such that the physiological monitor device:
receives a request to view a test comparison interface during a time that the display screen displays the first report in the test history interface;
displays the test comparison interface on the display screen in response to receiving the request to view the test comparison interface, the test comparison interface including controls for selection of a test for comparison against the given ECG test;
receives comparison input during at time that the display screen displays the test comparison interface, the comparison input indicating a reference test; and
concurrently displays, in response to receiving the comparison input, the first report and a second report in the test history interface, the second report containing details of the reference test.

20. The physiological monitor device of claim 14, wherein the physiological monitor device sends requests to store the results of the given ECG test to an interface system that translates the requests into requests that work with a software interface provided by the EMR system.
